(19) United States
(12) Patent Application Publication
(10) Pub. No.: US 2007/0146308 A1
(43) Pub. Date: Jun. 28, 2007

(54) Addressable brush contact array

(75) Inventors: Matthew E. Howard, San Francisco, CA (US); Nicholas K. Sheridon, Los Altos, CA (US)

Correspondence Address: John S. Zanghi, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION

(21) Appl. No.: 11/316,770

(22) Filed: Dec. 23, 2005

(51) Int. Cl. G09G 3/34

(52) U.S. Cl. 345/107

(57) ABSTRACT

An addressable brush contact array comprising oriented conductive fibers attached to addressing electrodes to transfer imagewise charge to or from an array of individual electrodes on a two dimensional surface. The two dimensional surface receiving this charge can be, for example, the writing surface of an electronic paper display or the drum of a xerographic printer. The addressing electrodes generally consist of one or more linear rows of electrodes on a narrow wand or addressing bar. More than one row of electrodes the electrodes of each row may be staggered with respect to the electrodes of adjacent rows to enable a high fill of charge transfer without creating fabrication problems by spacing the fibers too close on adjacent electrodes.

### BACKGROUND

This exemplary embodiment relates to the use of electronic display components for electric paper applications. The exemplary embodiment is designed for use with Gyricon electric paper but may also be used with electric paper based on liquid crystal, electrophoretic, and other field-effect display technologies as well as other applications.

Electric reusable paper (or EP) can be defined as any electronically-addressable display medium that approximates paper in form and function. Electric reusable paper should be light-weight, thin, and flexible, and it should display images indefinitely while consuming little or no power. In addition, electric reusable paper should be re-usable. One must be able to erase images and create new ones repeatedly. Preferably, electric reusable paper should display images using reflected light and allow a very wide-viewing angle.

One way to make electric reusable paper possible using traditional electronic display technology is to completely remove the driving electronics from an electronic display package and use external addressing electrodes to write and erase images. This approach reduces the per unit cost of electronic paper sheets and enables the use of cheap, flexible plastic films in place of glass plates for packaging. Multiple electronic paper sheets can then be addressed by a single set of external driving electronics, much like multiple sheets of pulp paper are printed on by a single printer.

An electronic sheet and display system named Gyricon is disclosed in various patents and articles, such as U.S. Pat. No. 4,126,854 to Sheridon, entitled “TWISTING BALL DISPLAY” and incorporated by reference herein. The Gyricon display system is comprised of a host layer a few mils thick which is heavily loaded with bichromal elements, possibly spheres, tens of microns in diameter. Each bichromal element has halves of contrasting colors, such as a white half and a black half. Each bichromal element also possesses an electric dipole, orthogonal to the plane that divides the two colored halves. Each bichromal element is contained in its own cavity filled with a dielectric liquid. Upon application of an electric field between electrodes located on opposite surfaces of the host layer, the bichromal elements will rotate depending on the polarity of the field, presenting one or the other colored half to an observer.

Over the years improvements have been made including the use of charge retaining island patterning on the electric reusable paper sheets. This technique has been described in various patents and publications, such as U.S. Pat. No. 6,222,513 to Howard et al., entitled “CHARGE RETENTION ISLANDS FOR ELECTRIC PAPER AND APPLICATIONS THEREFOR” and incorporated by reference herein.

Charge retaining island patterning refers to an electric reusable paper sheet that uses a pattern of conductive charge-retaining islands on the outward-facing side of at least one of two opposed outward surfaces. The second outward surface may also be coated with a conductive material, or made of a conductive material, and may or may not be patterned. The charge-retaining islands of the patterned surface or surfaces receive electric charges from an external charge-transfer device. The external charge-transfer device could have a plate configuration and be held over and in contact with the sheet, it could have a wand configuration and be pulled across the sheet, or it could have a stylus configuration and be used like a pen or pencil. After the charge-transfer device is removed, the conductive, charge-retaining islands hold electric charge, creating an electric field in the electric reusable paper of sufficient magnitude and duration to cause an image change.

An alternate embodiment of the charge retaining island approach that improves stability has been developed. The alternate embodiment utilizes charge retaining islands which are created as part of the bulk of the encapsulating layer instead of being patterned on the surface of the layer. Extending the conductivity of the charge retaining islands through the bulk of the encapsulating layer to the sheet contained therein improves the performance of the charge retaining islands and reduces the problem of image instability when handled immediately after addressing. This embodiment is implemented using a z-axis only conductive sheet material. Z-axis only sheet materials are generally made from an insulating host material which has been doped with conductive particles that transmit charge only in one axis.

A one-dimensional array of charge transfer elements has been developed and may be used like a print head or wand, as described in U.S. Pat. No. 5,389,945 to Sheridon, entitled “WRITING SYSTEM INCLUDING PAPER-LIKE DIGITALLY ADDRESSED MEDIA AND ADDRESSING DEVICE THEREFOR” and incorporated by reference herein.

FIG. 1 shows a one-dimensional array that uses a contact charging mechanism. This contact charging wand 10 is comprised of alternating conductive charge transfer elements 12 and insulating elements 14. The charge transfer elements must make reliable contact to the charge-retaining islands 16 while moving with respect to the electric paper sheet during image generation. Arrays using springy wire electrodes soldered to the edge of a printed circuit board have been proposed. More robust arrays utilizing anisotropically conductive elastomer connectors, or zebra connectors, well known in the art are also used. A one-dimensional array of ionographic addressing elements, well known in the art, is also a possibility for an external charge transfer wand.

The alignment of the array with the charge retaining islands need not be “perfect” as is shown in FIG. 1. It is simply necessary for each element to contact an island. For optimal alignment performance the array may have the same pitch as the islands, as shown in FIG. 1. However, individual array elements might transfer charge to a multiple number of charge retention islands. Further, individual array elements might be smaller than individual charge transfer islands but spaced at the same pitch as the charge transfer islands allowing for some tolerance in alignment between the individual array elements and the charge transfer islands. In all of these cases, the pitch of the elements in the charge transfer device should preferably be an integral number or fraction of the pitch of the charge transfer islands to avoid the creation of moiré effects.

As noted earlier, very thin and relatively wide zebra connectors have been used as contact arrays in conductive island printing. Zebra connectors are typically used in devices with LCD displays. In such cases, a zebra connector is interposed between the contact elements extending on the outside of the second leg and the surface portion of the printed circuit board where the contact traces are located. As known in the art, the zebra connector is a block consisting of sandwiched alternating layers of conducting and non-conducting elastomeric material, such as silicone elastomer. The material is very pliable, highly elastic, and chemically resistant. The conductive layers, or traces, are heavily loaded with conductive particles to give them current carrying capacity. Through the conducting layers of the zebra block, a satisfactory connection of the contact elements of the connector module with the contact traces on the printed circuit board is achieved.

Lying on its wide edge, half of the zebra connector can be clamped against the edge of a printed circuit board where traces that deliver printing data are terminated, leaving the other half to hang free off the edge of the printed circuit board. The cantilevered portion can be dragged across the patterned surface of an EP sheet like a squeegee and deliver image data to the conductive islands. The pliability and elasticity of the zebra connector enables micro-scale conformability to the sheet surface when sufficient downward force is applied. This helps to ensure that image data is delivered to the entire printing surface.

While the zebra connector exhibits desirable properties for a contact array and has been successfully used for 100 dpi printing demonstrations, for example, there are several factors that make them unsuitable for some commercial applications. These factors include resolution, durability, and drag.

The minimum conductive trace width is limited by the need to insure a continuous conductive path between adjacent conductive particles in the elastomer matrix. As traces are made thinner, the probability that a continuous path exists in the randomly dispersed particles is reduced. According to one manufacturer, for example, the minimum trace width for a zebra made with carbon particles is roughly 0.001 inches. The corresponding minimum pitch (trace to trace spacing) is 0.002 inches. While at first glance this would seem adequate for a 300 dpi printer, such zebra connectors will only work for printing in the 100 dpi range.

The primary reason for the resolution limitation is that the zebra connectors must rely on redundant contact to work predictably. In other words, the trace pitch must be significantly higher than the pitch of the driver pads on the printed circuit board. This is because the trace width and pitch is not well controlled in the manufacturing process, with tolerances being as large as 50% of nominal values. Furthermore, the zebra connectors are very elastic, so the dimensions change depending on how the connector is clamped. A second, related reason for the resolution limit is that the contact dimensions (pitch and trace width) must be compatible with both the island geometry and the dimensions of the driver pads. If the system is not properly designed, zebra traces, conductive islands, and driver pads can be electrically shorted together, resulting in blurring of the image, moiré patterns, and damage to the driver circuit (if there is not adequate protection).

Additionally, the durability of zebra connectors is an issue. The silicone elastomer strips are easily torn and sensitive to some oils. Because of this fragility, they are not robust in wand applications where the print head must be able to withstand handling. Zebra connectors also wear out overtime. Conductive particles are stripped from the outer layers of the elastomer matrix, reducing their electrical contact efficiency. In being used like a squeegee, the connectors also capture a lot of the dirt that resides on the EP surface as it passes. Cleaning mechanisms are therefore needed to prevent buildup on the zebra connector strip.

Because considerable downward force must be used in pressing the zebra connector against the EP sheet, there is considerable drag on the EP sheet in the printing process. This not only puts extra mechanical demands on the design of the EP package, but increases the torque requirements, and, subsequently, the minimum size of the motor used in a printer's paper feed system.

Thus, with respect to electronic display applications, there is a need for an addressable brush contact array that has better resolution, is more durable and has reduced drag, when compared to any of the known elastomer connectors.

### BRIEF DESCRIPTION

The exemplary embodiment disclosed herein relates to the use of oriented conductive fibers attached to addressing electrodes to transfer imagewise charge to or from an array of individual electrodes on a two dimensional surface. The two dimensional surface receiving this charge can be, for example, the writing surface of an electronic paper display or the drum of a xerographic printer. The addressing electrodes generally consist of one or more linear rows of electrodes on a narrow wand or addressing bar. More than one row of electrodes may be used and the electrodes of each row may be staggered with respect to the electrodes of adjacent rows to enable a high fill of charge transfer without creating fabrication problems or shorting by spacing the fibers too close on adjacent electrodes.

In one embodiment there is provided a method comprising mechanically scanning an addressable brush contact array over a two dimensional array of electrodes on an insulating surface and depositing imagewise charge on the electrodes, sampling charge on the electrodes or removing charge from the electrodes.

In another embodiment there is provided an apparatus for depositing imagewise charge on an array of electrodes on an insulating surface, sampling charge on the electrodes or removing charge from the electrodes. The apparatus comprises an array of flexible brushes, each brush comprising one or more conductive fibers, and each bonded to and electrically continuous with an electrode, the electrode addressable by an external electronic switching means; and scanning means for mechanically scanning the conductive brush array and a two dimensional array of electrodes on an insulating surface relative to each other, wherein electrical charge is transferred imagewise to the two dimensional array from the conductive brush array or transferred from the two dimensional array to the conductive brush array.

In yet another embodiment there is provided an apparatus for transferring charge from an electrode on one surface to or from charge retention electrodes on a different surface during a mechanical scanning in which the surfaces are moved relative to one another. The apparatus comprises a conductive brush bonded to and electrically continuous with the first of the electrodes, wherein the non-bonded end of the brush is positioned so as to allow electrical contact with one or more charge retention electrodes on the second surface at one or more instants of time during scanning; an electrical circuit for sending voltage signals to or receiving signals from the electrode each brush is bonded to and electrically continuous with; and means for preventing dirt and dust from accumulating on the conductive brushes during operation or means to periodically clean said brushes, such as by passing them through a comb-like structure.

### BRIEF DESCRIPTION OF THE DRAWINGS

FIG. 1 is a perspective view of a gyricon sheet showing a known arrayed charge transfer device.

FIG. 2 is a perspective view of one embodiment of a brush contact array.

FIG. 3 is a perspective view of a wand connected to a printed circuit board in accordance with aspects of the exemplary embodiment.

FIG. 4 shows one way of fabricating a scanning system in accordance with aspects of the exemplary embodiment.

FIG. 5 is a perspective view of alternative embodiment of a brush contact array.

FIG. 6 illustrates one method of manufacturing the brush contact array shown in FIG. 5.

FIG. 7 illustrates the flocking manufacturing process in accordance with aspects of the exemplary embodiment.

FIG. 8 is a top view of an electronic paper display sheet having electrically and non-electrically generated markings thereon, and a wand for capturing the composite information.

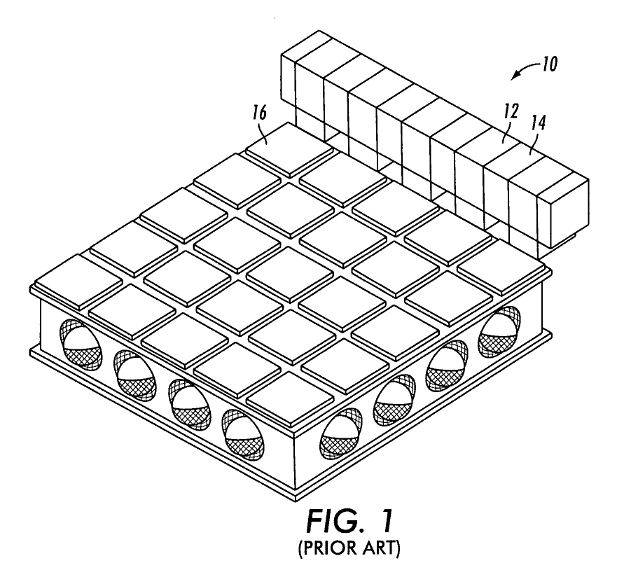

### DETAILED DESCRIPTION

The addressable brush contact array described herein involves the use of oriented conductive fibers attached to addressing electrodes to transfer imagewise charge to or from an array of individual electrodes on a two-dimensional surface (The charge retention electrodes). The two-dimensional surface can be the writing surface of an electronic paper display or the drum of a xerographic printer.

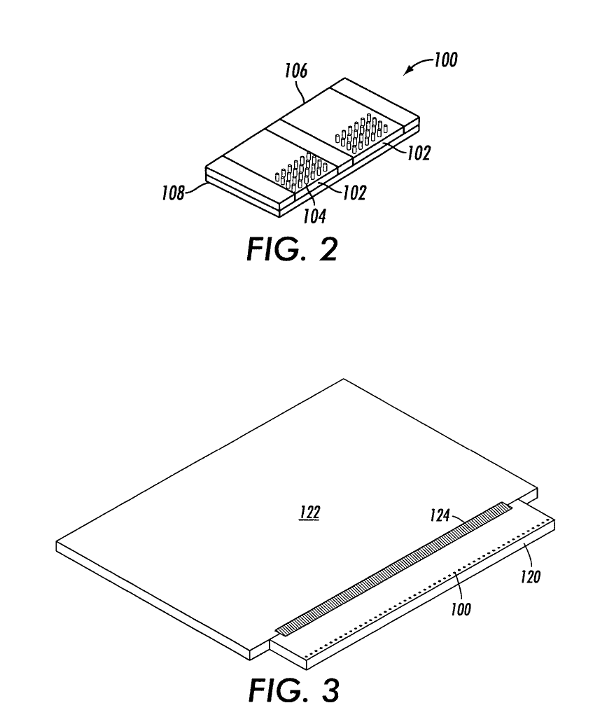

With reference now to FIG. 2, an addressable brush contact array 100 is shown. The array 100 comprises one or more linear rows 102 of addressing electrodes that can be mounted on a narrow wand or addressing bar (not shown). If there is more than one row of electrodes, then the electrodes of each row would be staggered with respect to the electrodes of adjacent rows to enable a high fill of charge transfer without creating fabrication problems by spacing the fibers too close on adjacent electrodes.

Thus, the brush contact array 100 may be thought of as a brush made with rows of conductive fibers or bristles 104 that do not electrically contact each other. Because they do not touch, adjacent individual fibers or groups of fibers 104 can deliver isolated electrical signals. The fibers 104 are attached directly to conductive traces 106 on a substrate 108 that can be mated to traces on a circuit board (or other electronic circuit substrate). Alternatively, the fibers 104 can be attached directly to the traces 104 of the circuit board.

The substrate 108 may be a flexible film such as Mylar, polyimide, or it may be very flat and rigid, such as glass or dielectric coated metal.

The fibers 104 are to be conductive and made from a very wide choice of materials. They are generally made from polymers such as rayon, nylon, Teflon, etc., and the conductivity will be imparted by the addition of conductive pigments (such as silver, carbon, etc), conductive polymer admixes such as anthracene and pentacene, fibers coated with metal, fibers coated with chemicals such as metal salts that attain conductivity by accumulating water from the air, etc. They may also be made from metals such as gold, nickel and tungsten. Preferred materials include graphite and conductive polymers. Polymer fibers are currently available in a variety of lengths ranging from 0.010 inches to 0.040 inches and thicknesses ranging from 0.001 inches to more than 0.005 inches.

Charge is transferred from the addressing electrodes 102 to the charge retention electrodes of the two dimensional surface through the conductive fibers touching the conductive charge retention electrodes. Such contact may be enhanced by giving the brush abrasive properties (addition of abrasive pigments to the interior or surface of the fiber, for example), such that a layer of non-conducting oxides or other insulator is scraped off the charge retention electrode surface as the brush traverses it, more easily allowing ohmic contact.

The number of fibers 104 attached to each addressing electrode 102 may be as few as one, but will generally be 10 to 100, enough to assure good contact with the receiving electrode under realistic conditions of surface contamination. A high density of fibers also enables the brush to be stiffer and more robust. Staggered electrodes on the addressing electrode favor a high density of fibers on each addressing electrode. Short fibers of thin cross section are best suited to high resolution addressing. For example, a 300 dot per inch addressing array might have individual electrodes 0.003 inches wide. This would accommodate as many as nine fibers having a diameter of 0.001 inches on its surface, or 36 fibers having a diameter of 0.0005 inches.

The manufacturing tolerances on the brush contacts can be much tighter than those on the zebra connector, so it is possible to use a brush contact in a one-to-one contact mode. For example, a 0.004 inch pitch brush contact is useful for 250 dpi printing, but a 0.004 inch pitch zebra connector is barely useful for 100 dpi printing. Fiber diameter determines the absolute lower limit for brush resolution. Carbon fibers with diameters of less than 1 mil may be used. The minimum spacing of fibers is determined by how uniformly they can be distributed and by their tendency to bend into one another in operation, thereby shorting. Maintaining a low length to diameter ratio can minimize fiber bending. The bending problem might be bypassed altogether if the conductive fibers are coated with a thin layer of insulating material, leaving only portions of exposed conductive material at the fiber end.

Conductive carbon fiber bristles and polymer fiber bristles should be more resilient than elastomer, given the superior mechanical properties of these materials. Carbon fibers are also very resistant to chemicals so routine handling should not be as big a problem for brushes as for zebras. Due to the resilience of carbon and polymer materials, a carbon or polymer brush is more amenable to routine cleaning during operation, making the problem of dirt and dust collection more tenable.

Brush contacts do not require as much downward, drag-inducing force to make reliable electrical contact. Carbon and polymers are very smooth materials, often used as lubricants, and should slide more easily across the surface than elastomer filled with metallic particles. Furthermore, the brush should contact the EP surface at relatively fewer points than the elastomer does, and so, create less frictional area.

The first step in manufacturing the brush contact array 100 is to create an array of closely spaced parallel traces 106 of a conductive adhesive layer such as an unhardened conductive epoxy resin or other uncured conductive material. The traces 106 are constructed on the substrate 108. Depending on the desired resolution, the adhesive traces can be made by screen-printing the epoxy or doctoring the epoxy into a micro-replicated rib structure, as described later. Other high resolution methods of applying the conductive adhesive traces include offset printing and inkjet printing.

Next, the conductive fibers must be inserted into the conductive adhesive material and the material cured or hardened. The preferred method of applying fibers to the addressing electrodes is by means of flocking. This is a low cost and widely practiced manufacturing process capable of producing a high density of oriented fibers. Flocking creates a brush where the fibers are all oriented parallel to each other and perpendicular to the conductive traces. Flocking fibers, which are conductive and may be carbon or polymers, come in hundreds of different diameters, lengths, and materials. Flocking is used, for example, to produce a velvet-like coating of fibers on surfaces used to display jewels, on glove box surfaces in automobiles, and on upholstery used on furniture and automobile seats. It can be applied with great uniformity and the product can be highly robust.

Generally, flocking is accomplished by coating the surface to be flocked with an adhesive, placing a conductive electrode under this surface, producing a loose assembly of flocking fibers at some distance from the receiving surface and charging these fibers such that a very strong electrical field created by placing an electrode in the vicinity of the fiber assembly and applying a high voltage between this electrode and the electrode under the surface to be flocked causes the flocking fibers to be pulled strongly to the latter surface and to be oriented in the electrical field such that they arrive at the surface aligned with the field lines, generally perpendicular to the surface. Subsequently the adhesive is solidified by solvent extraction, curing or other method characteristic of the adhesive.

This adhesive must be conductive for use with the brush contact array 100 because it must provide electrical continuity between the conductive fibers and the electrodes the fibers are bonded to. Conductive adhesives include conductive epoxies (such as those manufactured by the Conductive Compounds Company) and conductive paints (such as “Silver-Met” manufactured by Transene). A preferred conductive adhesive is Electrodag 440B manufactured by Acheson Colloids. This material is well suited to silkscreen application, which is the preferred method of applying the conductive adhesive. It is cured by subsequently heating it to 50 degrees C. for 30 minutes. During this curing time an electrical field may be applied to maintain the orientation of the fibers on the surface. Other methods of applying the conductive adhesive include the use of ink jet and offset printing techniques, which precisely apply the conductive adhesive over the addressing electrodes.

The addressable brush contact array 100 can be integrated into the addressing electronics system in several ways. Perhaps the most straightforward way is to make a detachable wand 120 that connects to a printed circuit board 122 by means of a connector 124, as illustrated in FIG. 3. Such a wand 120 would be itself a narrow printed circuit board with the brush array 100 on one side and the connector 124 on the other side.

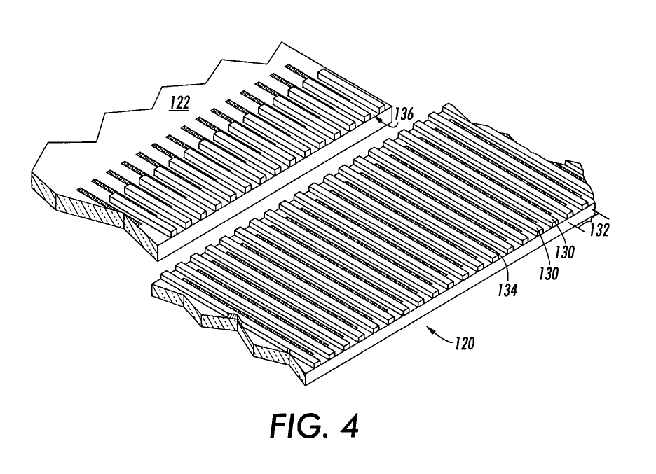

A convenient way of fabricating such a system would be to overlay a micro-replicated rib structure over the electrode pattern, as shown in FIG. 4. A pair of ribs 130 would define a trench 132, with an electrode trace 134 at the bottom of the trench 132, the fiber contact at one end of the trench 130 and the other end of the trench 130 free of fibers for making electrical contact with a mating rib structure 136 on the larger printed circuit board 122. It is to be understood that the wand 120 flips over and onto the printed circuit board 122, where its ribs 130 interlock with the grooves on the printed circuit board 122. This rib structure can be used to mechanically self-align the connector 124 to the pads on the edge of the driver circuit board during assembly. A similar connector without the rib structure is also feasible, but optical, electronic, or other mechanical means would have to be used to align the connector to the driver board pads. Another alternative is to manufacture the brush directly on the edge of the printed circuit board using techniques already described.

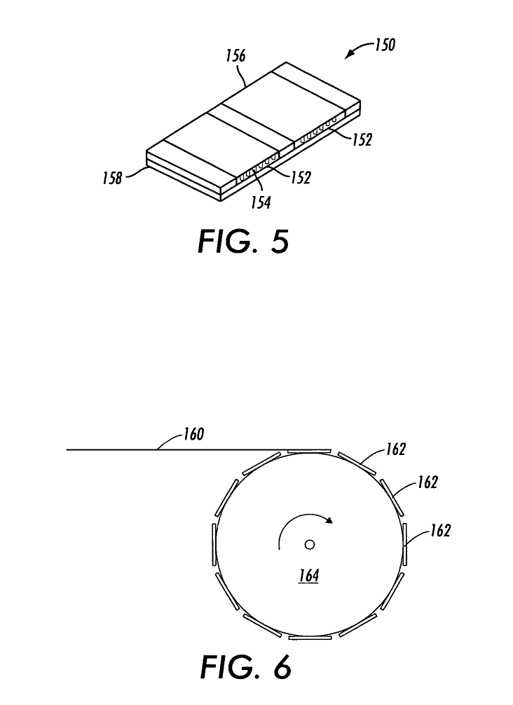

An alternative embodiment of the addressable brush contact array is illustrated in FIG. 5. An alternative brush contact array 150 includes rows of addressing electrodes 152, threads or bristles 154 and traces 156 on a substrate 158. This embodiment is manufactured by pulling the conductive fiber strand 154 lengthwise along each trace 156, curing, and then trimming the strand 154 that extends past the edge of the substrate 158, parallel to the trace 156. The process could be facilitated by wrapping the flexible substrate 158, with the traces 156 on it, around a rotating drum and then unwinding a conductive thread at a uniform rate around the drum, somewhat like cutting a screw thread on a lathe. This manufacturing process is illustrated in FIG. 6 for a conductive fiber 160 and a large number of detachable wands 162 arrayed around a cylinder 164. An important virtue of this method of producing the brush contact array is that the fibers end up protruding over the edge of the wand (or printed circuit board) rather than normal to it, facilitating its use in some applications.

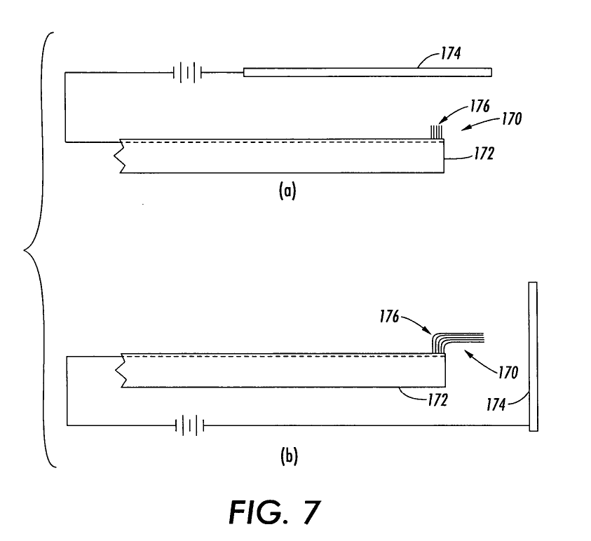

Another method of producing a brush contact array 170 that protrudes over the edge of a printed circuit board 172 using the flocking manufacturing process is illustrated in FIG. 7. The flocked array of addressing brushes 170 is produced in the usual way, but instead of placing an electrode 174 parallel to the surface of the printed circuit board 172 to cause the fibers 176 to be perpendicular to the surface of the board during the adhesive curing process, as shown in (a), the electrode 174 is placed at right angles to the edge of the board 172, causing the conductive fibers 176 to protrude over the edge of the board 172 during cure, as shown in (b).

In usage, the conductive fibers of the addressable brush contact array may collect unwanted debris from the surfaces they contact. This problem may be diminished by placing a non-conducting brush or flocked array ahead of the addressing flocked array. This array of non-conductive fibers may be cleaned by passing it through a rigid comb periodically. The same technique may be used to clean the addressing brushes.

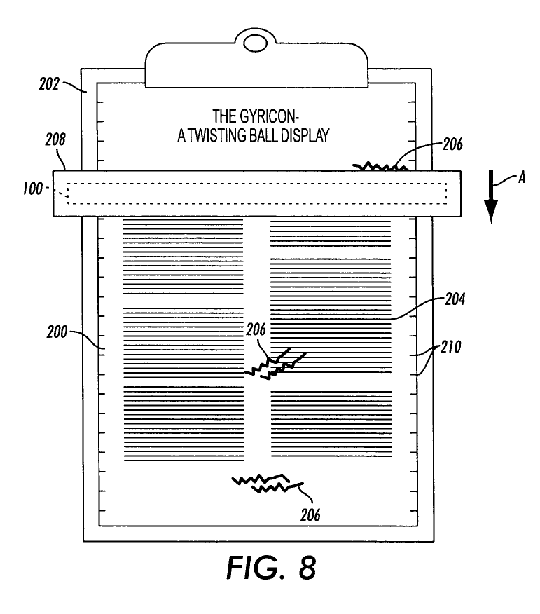

Exemplary uses of the flocked addressing electrode technique described above include the aforementioned electronic paper and as well as xerographic printers. For example, in FIG. 8 there is shown a display sheet 200 supported upon a backing member 202, such as a clipboard, for providing a convenient support for the flaccid sheet during addressing. The display sheet 200 may contain hand drawn markings 204 as well as printed text 206. A hand held addressing wand 208, connected to a work station (not shown) by any suitable wireless means, for example, infrared diodes, acoustics or radio, housing an addressable brush contact array 100, is passed over the display sheet 200 (as indicated by the arrow A) for writing information transmitted from the remote work station onto the display sheet 200. An entire 8.5×11 inch surface may be written on in times as short as one second by drawing the wand over the length of the display sheet 200. This enables the user to be comfortably seated across the room from the workstation. Registration marks 210 may be provided on both sides of the display sheet 200 for cooperating with suitable sensors (such as optical or magnetic) in the addressing wand 208 in order to track wand speed and alignment. Thus, there is interaction between the wand 208, the workstation and the display sheet 200 so that correct information is transmitted and written. After the document has been written onto one or more display sheets, the user has several available options. The user may read them, carry them away, or copy them onto paper at a copier. In the latter instance, the combination of the novel display system and the conventional copier is comparable to a very low cost printer and obviates the need for that extra piece of equipment.

The paper-like addressable sheet 200 is unencumbered by an integral addressing array. As noted above, the addressable brush contact array 100 in the addressing wand 208, which is movable relative to the surface of the display sheet 200, supplants an integral 2-D addressing matrix in the prior art devices. As the addressing wand is moved relative to the display sheet 200 and the voltages on its individual modulating electrodes in the array 100 are switched in accordance with the pixel information of the document to be written, appearing on a remote work station, an electrical field will be established between the electrodes and an electrically conductive ground plane (not shown) disposed on the opposite side of the display sheet. This-conductive plane may be in the form of a conductive layer located on the backing member or it may be a thin conductive layer deposited, as by evaporation, directly upon the remote surface of the display sheet 200, as described in the '945 patent.

In the case of xerographic printers, the dielectric (not photoconductive) drum of a xerographic printer could contain the same array of charge retention islands that receive charge from an addressable brush array. The charged islands would subsequently attract image-wise toner, which would in turn be transferred to paper and fused. This would make a very low cost and reliable printer.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
mechanically scanning an addressable brush contact array over a two dimensional array of electrodes on an insulating surface; and
depositing imagewise charge on said electrodes, sampling charge on said electrodes or removing charge from said electrodes.

2. The method of claim 1 wherein said insulating surface is positioned on one side of a voltage addressable display medium.

3. The method of claim 1 wherein said insulating surface is one side of a xerographic charge receptor.

4. The method of claim 1 wherein said insulating surface is positioned on one or both sides of an electronic paper display medium.

5. The method of claim 4 wherein said insulating surface is positioned on one or both sides of a Gyricon display medium, an electrophoretic display medium, an electrowetting display medium or a liquid crystal display medium.

6. An apparatus for depositing imagewise charge on an array of electrodes on an insulating surface, sampling charge on said electrodes or removing charge from said electrodes, said apparatus comprising:
an array of flexible brushes, each brush comprising one or more conductive fibers, and each bonded to and electrically continuous with an electrode, said electrode addressable by an external electronic switching means; and
scanning means for mechanically scanning said conductive brush array and a two dimensional array of electrodes on an insulating surface relative to each other, wherein electrical charge is transferred imagewise to said two dimensional array from said conductive brush array or transferred from said two dimensional array to said conductive brush array.

7. The apparatus of claim 6 wherein said conductive brushes are aligned perpendicular to the surfaces of the electrodes to which they are bonded.

8. The apparatus of claim 6 wherein said conductive brushes are aligned at an angle between 0 degrees and 180 degrees to the planes of the electrodes to which they are bonded.

9. The apparatus of claim 6 wherein the insulating surface said two dimensional array of charge retention electrodes resides on is sufficiently high in conductivity to allow charge to substantially bleed from said islands during the time between scans.

10. The apparatus of claim 6 further comprising means for removing charge from said charge retention electrodes during or prior to scanning.

11. An apparatus for transferring charge from an electrode on one surface to or from charge retention electrodes on a different surface during a mechanical scanning in which said surfaces are moved relative to one another, said apparatus comprising:
a conductive brush bonded to and electrically continuous with the first of said electrodes, wherein the non-bonded end of said brush is positioned so as to allow electrical contact with one or more charge retention electrodes on said second surface at one or more instants of time during scanning;
an electrical circuit for sending voltage signals to or receiving signals from the electrode each brush is bonded to and electrically continuous with; and
means for preventing dirt and dust from accumulating on said conductive brushes during operation or means to periodically clean said brushes, such as by passing them through a comb-like structure.

12. The apparatus of claim 11 comprising one or more conductive fibers with sufficient mechanical stiffness to substantially retain the shape of the brush yet soft enough to make electrical contact with an electrode without causing significant mechanical damage to said electrode.

13. The apparatus of claim 11 in which at least some of the fibers are slightly abrasive in order to remove surface oxides and other impediments to making good electrical connections.

14. The apparatus of claim 11 in which the conductive fibers are comprised of metal wires.

15. The apparatus of claim 11 in which the conductive fibers are comprised of graphite or other forms of carbon.

16. The apparatus of claim 11 in which the conductive fibers are comprised of one or more polymers.

17. The apparatus of claim 11 in which the conductive fibers are transported to and bonded with their electrodes by means of the flocking process.
